(19) United States
(12) Patent Application Publication
(10) Pub. No.: US 2011/0064498 A1
(43) Pub. Date: Mar. 17, 2011

(54) IMAGE FORMING SYSTEM AND IMAGE FORMING DEVICE

(75) Inventor: Yukitoshi Takano, Ebina-shi (JP)

(73) Assignee: FUJI XEROX CO., LTD., Tokyo (JP)

(21) Appl. No.: 12/793,283

(22) Filed: Jun. 3, 2010

(30) Foreign Application Priority Data
Sep. 14, 2009 (JP) 2009-212138

(51) Int. Cl. G03G 15/00

(52) U.S. Cl. 399/384

(57) ABSTRACT

A first image forming component forms an image on one side of the continuous paper conveyed by a first conveyance component based on a first reference position. The first reference position is a position that is disposed away from the first side edge of the continuous paper by a first width which is one of a measured width of the continuous paper and a pre-specified width for the continuous paper. A second image forming component forms an image on the other side of the continuous paper conveyed by a second conveyance component based on a second reference position. The second reference position is a position that is disposed away from the second side edge by a second width which is the other of the measured width of the continuous paper and the pre-specified width for the continuous paper.

### CROSS-REFERENCE TO RELATED APPLICATION

This application is based on and claims priority under 35 USC 119 from Japanese Patent Application No. 2009-212138 filed Sep. 14, 2009.

### BACKGROUND

1. Technical Field

The present invention relates to an image forming system and an image forming device.

2. Related Art

Heretofore, a printing device has been known that: receives a command that specifies an arbitrary width and length in relation to the size of a page to be printed and a command that specifies a printing direction category; sets an specified origin point and printing direction for physical paper as reference criteria; arranges a logical page with a size of the width and height specified by the command on the physical page; and prints on one face of the paper on this logical page.

Further, a two-sided printer device is known that includes: a paper width measurement component that measures a paper width of continuous paper for printing; a print start position control component that calculates a printing start position on the basis of measurement results from the paper width measurement component; and a memory component that memorizes measured values of paper width that have been set up to just before a current measurement of paper width.

### SUMMARY

According to an aspect of the invention, there is provided an image forming system. The image forming system includes: an inversion mechanism that inverts continuous paper between one side and the other side of the continuous paper; an upstream side image forming device; and a downstream side image forming device. The upstream side image forming device includes: a first conveyance component that aligns a first side edge of the continuous paper with a reference surface provided along a conveyance direction and conveys the continuous paper in a conveyance direction, the conveyance direction being in a paper continuation direction; and a first image forming component that forms an image on one side of the continuous paper conveyed by the first conveyance component based on a first reference position, the first reference position being a position that is disposed away from the first side edge of the continuous paper by a first width which is one of a measured width of the continuous paper and a pre-specified width for the continuous paper, and the downstream side image forming device includes: a second conveyance component that aligns a second side edge, which is opposite to the first side edge, of the continuous paper with a reference surface provided along the conveyance direction and conveys the inverted continuous paper by the inversion mechanism in the conveyance direction; and a second image forming component that forms an image on the other side of the continuous paper conveyed by the second conveyance component based on a second reference position, the second reference position being a position that is disposed away from the second side edge by a second width which is the other of the measured width of the continuous paper and the pre-specified width for the continuous paper, and wherein the upstream side image forming device is disposed at a upstream side of the inversion mechanism in the conveyance direction, and the downstream side image forming device is disposed at a downstream side of the inversion mechanism in the conveyance direction.

### BRIEF DESCRIPTION OF THE DRAWINGS

An exemplary embodiment of the present invention will be described in detail based on the following figures, wherein:

FIG. 1 is a schematic diagram illustrating structure of an image forming system relating to a first exemplary embodiment of the present invention;

FIG. 2 is a diagram illustrating a state in which continuous paper is inverted by a turn bar mechanism of an inversion device;

FIG. 3 is a diagram illustrating a state in which the continuous paper is cut at a post-processing device;

FIG. 4 is a diagram illustrating states in which width direction side edges of the continuous paper abut against conveyance reference surfaces;

FIG. 5 is a block diagram illustrating structure of the image forming system relating to the first exemplary embodiment of the present invention;

FIG. 6 is a block diagram illustrating functional structure of a system controller of an upstream side system of the image forming system relating to the first exemplary embodiment of the present invention;

FIG. 7 is an image diagram illustrating a state in which images represented by first face print data, color adjustment marks, and page adjustment marks are formed on a first face of the continuous paper;

FIG. 8A is a diagram for describing a method of determining an image formation reference position, using measured width information;

FIG. 8B is a diagram for describing a method of determining an image formation reference position, using pre-specified width information;

FIG. 9A is a diagram for describing a method of determining a dot position that serves as an image formation reference position, using measured width information;

FIG. 9B is a diagram for describing a method of determining a dot position that serves as an image formation reference position, using pre-specified width information;

FIG. 10 is a block diagram illustrating functional structure of a system controller of a downstream side system of the image forming system relating to the first exemplary embodiment of the present invention;

FIG. 11 is a diagram illustrating states in which a width direction side edge of the continuous paper abuts against conveyance reference surfaces;

FIG. 12A is a diagram for describing a method of determining an image formation reference position, using measured width information;

FIG. 12B is a diagram for describing a method of determining an image formation reference position, using pre-specified width information; and

FIG. 13 is a schematic diagram illustrating structure of an image forming system relating to a third exemplary embodiment of the present invention.

### DETAILED DESCRIPTION OF THE INVENTION

Herebelow, exemplary embodiments of the present invention are described with reference to the drawings.

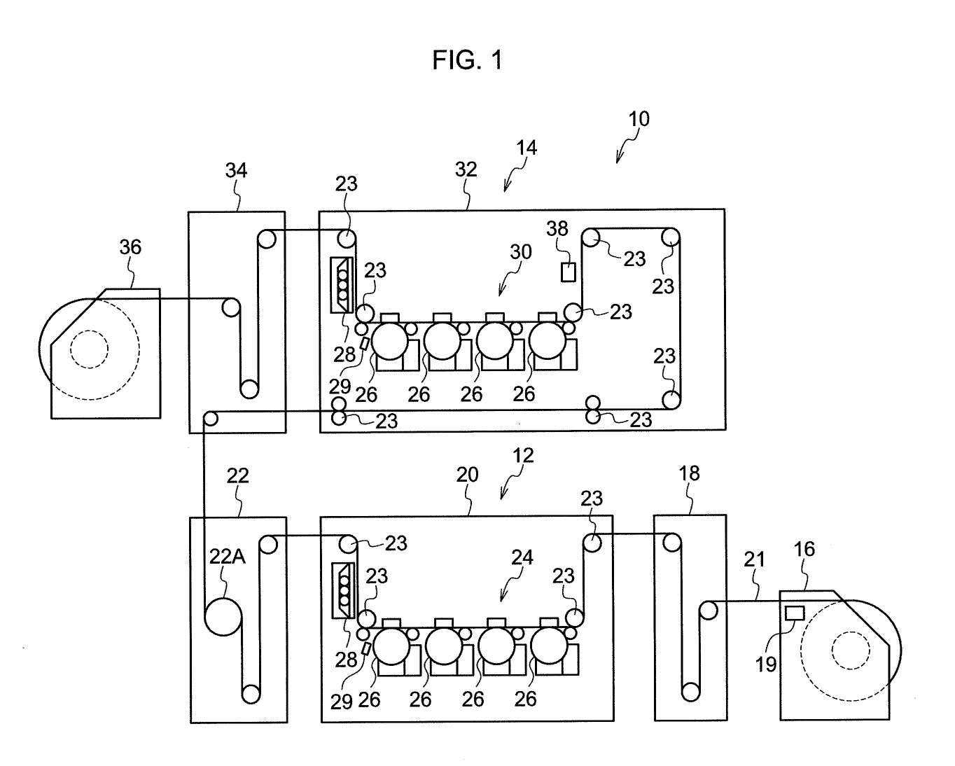

As illustrated in FIG. 1, an image forming system 10 relating to a first exemplary embodiment of the present invention is provided with an upstream side system 12 at an upstream side of a conveyance direction, and a downstream side system 14 at the conveyance direction downstream side.

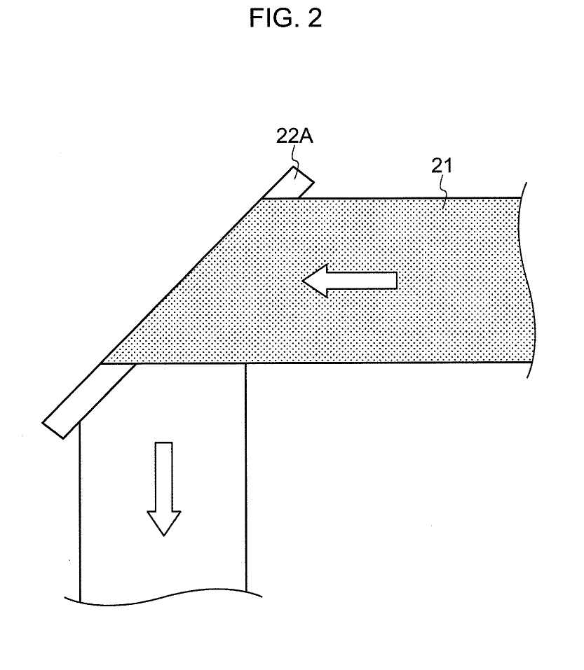

The upstream side system 12 is provided with a pre-processing device 16, a buffer device 18, an image forming device 20 and an inversion device 22. Continuous paper 21 is paper that is loaded at the pre-processing device 16 and is continuous in one direction. The continuous paper 21 is supplied through the buffer device 18 to the image forming device 20, image forming is performed on one face (a first face) of the continuous paper 21 by the image forming device 20, and then the continuous paper 21 passes through the inversion device 22 and is inverted, and is conveyed to the downstream side system 14. The pre-processing device 16 performs various kinds of pre-processing before image formation is carried out on the continuous paper 21 (for example, punching, creation of perforation lines and the like). The inversion device 22 is provided with a turn bar mechanism 22A and switches between the first face and the second face of the continuous paper 21 (inverts between the same). As illustrated in FIG. 2, when the first face and second face of the continuous paper 21 are inverted by the turn bar mechanism 22A, width direction edges of the continuous paper 21 are also inverted. In the present exemplary embodiment, a case is described in which the upstream side system 12 and the downstream side system 14 use toners as materials for forming images and the images are formed on the continuous paper 21.

The buffer device 18 and the inversion device 22 are structured to accumulate the continuous paper 21 up to pre-specified amounts. The buffer device 18 absorbs a difference between a processing speed of the pre-processing device 16 and a processing speed of the image forming device 20. The inversion device 22 absorbs a difference between the processing speed of the image forming device 20 and a processing speed of the downstream side system 14.

The pre-processing device 16 is provided with a paper width measurement sensor 19. A paper width of the continuous paper 21 loaded in the pre-processing device 16 is measured by the paper width measurement sensor 19.

The image forming device 20 is provided with plural conveyance rollers 23 that convey the continuous paper 21 supplied by the pre-processing device 16 in a paper conveyance direction by means of nipping pressure. Thus, the continuous paper 21 is conveyed along a conveyance path. The image forming device 20 is provided with an image forming mechanism 24, and forms images on the continuous paper 21. The image forming mechanism 24 is structured to form images on the continuous paper 21 by an electrophotography system. Specifically, a charging device, an exposure device, a developing device, a transfer device, a cleaning device, a neutralizing device and suchlike are arranged in this order around each of photoreceptor drums 26 that correspond to cyan, magenta, yellow and black, and a fixing device 28 is disposed at the downstream side of the conveyance direction of the continuous paper.

That is, each photoreceptor drum 26 is rotated, the surface of the photoreceptor drum 26 is uniformly charged by the charging device, and a latent image is formed by the exposure device at the surface of the photoreceptor drum 26. Then the latent image formed at the surface of the photoreceptor drum 26 is developed by the developing device and a toner image is formed, and this toner image is transferred to the continuous paper 21 by the transfer device. The toner images that have been transferred to the continuous paper 21 are fixed by the fixing device 28. Toner that remains on the surface of the photoreceptor drum 26 instead of being transferred to the continuous paper 21 by the transfer device is removed by the cleaning device, and the surface of the photoreceptor drum 26 is de-electrified by the neutralizing device. Subsequently, the above-described processing, from charging by the charging device, is repeated, and thus images are formed. Herein, an image forming device that performs color image formation is illustrated in FIG. 1, but this is not to be limiting. An image forming device that is provided with one photoreceptor drum 26 and that carries out monochrome image forming may be used.

The image forming device 20 is provided with a color adjustment mark reading device 29 on the conveyance path at the downstream side relative to the photoreceptor drums 26. The color adjustment mark reading device 29 is constituted with, for example, a spot-type optical sensor, and one-dimensionally reads color adjustment marks that are formed as images on a first face of the continuous paper 21 that is being conveyed.

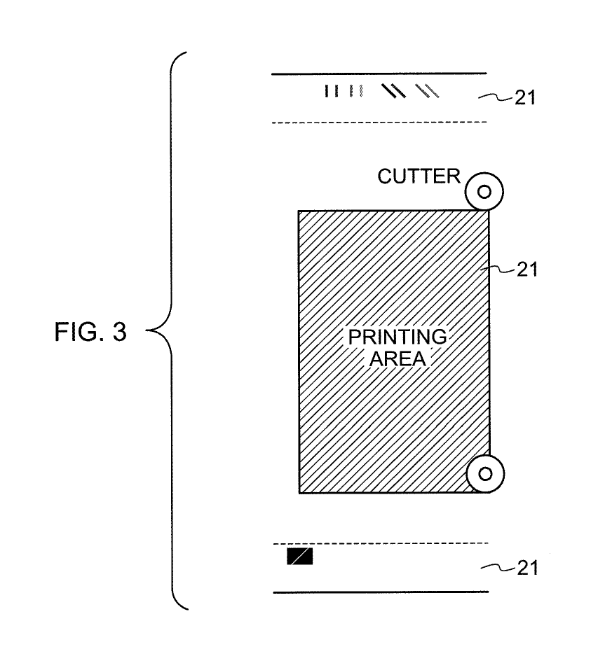

The downstream side system 14 at the conveyance direction downstream side is provided with an image forming device 32, a buffer device 34 and a post-processing device 36. The continuous paper 21 that is conveyed from the inversion device 22 passes through the buffer device 34 and is supplied to the image forming device 32. An image is formed on the other face (the second face) of the continuous paper 21 by the image forming device 32, and then the continuous paper 21 passes through the buffer device 34 and is conveyed to the post-processing device 36. The post-processing device 36 rolls up the continuous paper 21 and performs various kinds of post-processing on the continuous paper 21 on both of whose faces images have been formed by the image forming device 20 and the image forming device 32. For example, the post-processing device 36 cuts the continuous paper 21 to the size of regions at which images are formed, as illustrated in FIG. 3.

The buffer device 34 is structured to accumulate the continuous paper 21 in a pre-specified amount. The buffer device 34 absorbs a difference between a processing speed of the image forming device 32 and a processing speed of the post-processing device 36.

The image forming device 32 is provided with the conveyance rollers 23 and an image forming mechanism 30 similar to the image forming mechanism 24 of the image forming device 20. The image forming device 32 conveys the continuous paper 21 along the conveyance path and forms images at the other face (the second face) of the continuous paper 21. Charging devices, exposure devices, developing devices, transfer devices, cleaning devices, neutralizing devices and suchlike are arranged in this order around the photoreceptor drums 26 that correspond to cyan, magenta, yellow and black in the image forming mechanism 30, and the fixing device 28 is disposed at the continuous paper conveyance direction downstream side thereof. The image forming device 32 is provided with the color adjustment mark reading device 29 on the conveyance path at the downstream side relative to the photoreceptor drums 26.

The image forming device 32 is provided with a page adjustment mark reading device 38 on the conveyance path at the upstream side relative to the image forming mechanism 30. The page adjustment mark reading device 38 is constituted with, for example, a spot-type optical sensor to one-dimensionally read page adjustment marks that are formed as images on the first face of the continuous paper 21 that is being conveyed.

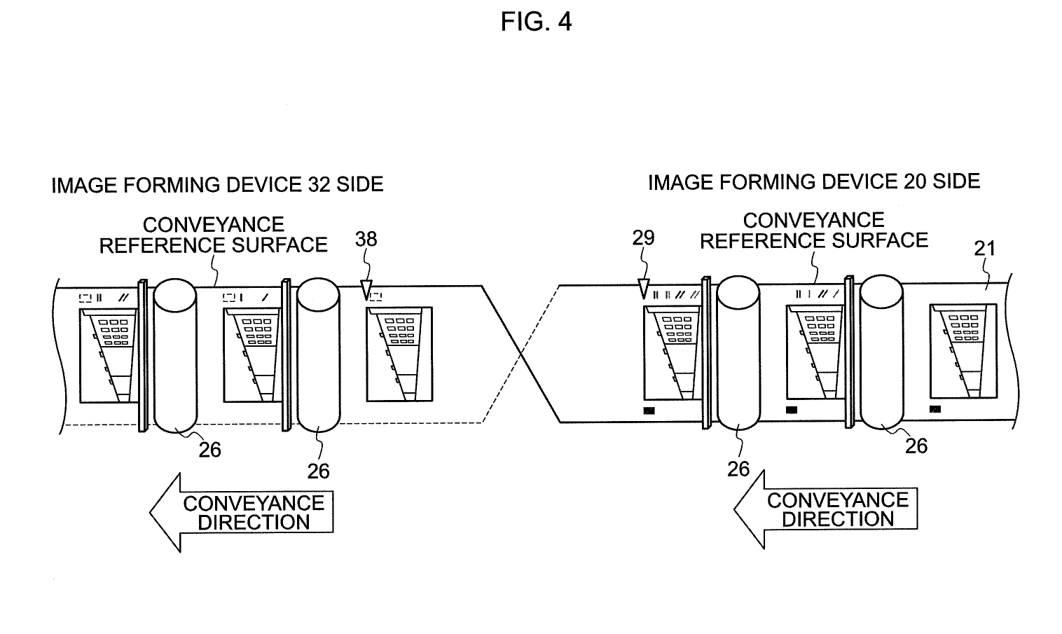

In the image forming device 20, as illustrated in FIG. 4, the edge at one side of the width direction of the continuous paper 21 is abutted against a conveyance reference surface provided along the conveyance direction at the conveyance path, and is conveyed. Because the continuous paper 21 is inverted between front and rear by the inversion device 22 such that the width direction edges of the continuous paper 21 are exchanged, in the image forming device 32, the edge at the other side of the width direction of the continuous paper 21 is abutted against a conveyance reference surface provided along the conveyance direction at the conveyance path, and is conveyed. In the present exemplary embodiment, a case in which the conveyance reference surfaces in the image forming devices 20 and 32 are disposed at the same side of a direction orthogonal to the conveyance direction of the conveyance path and the width direction side edges of the continuous paper 21 that are abutted against the conveyance reference surfaces are different between the image forming devices 20 and 32 is described as an example.

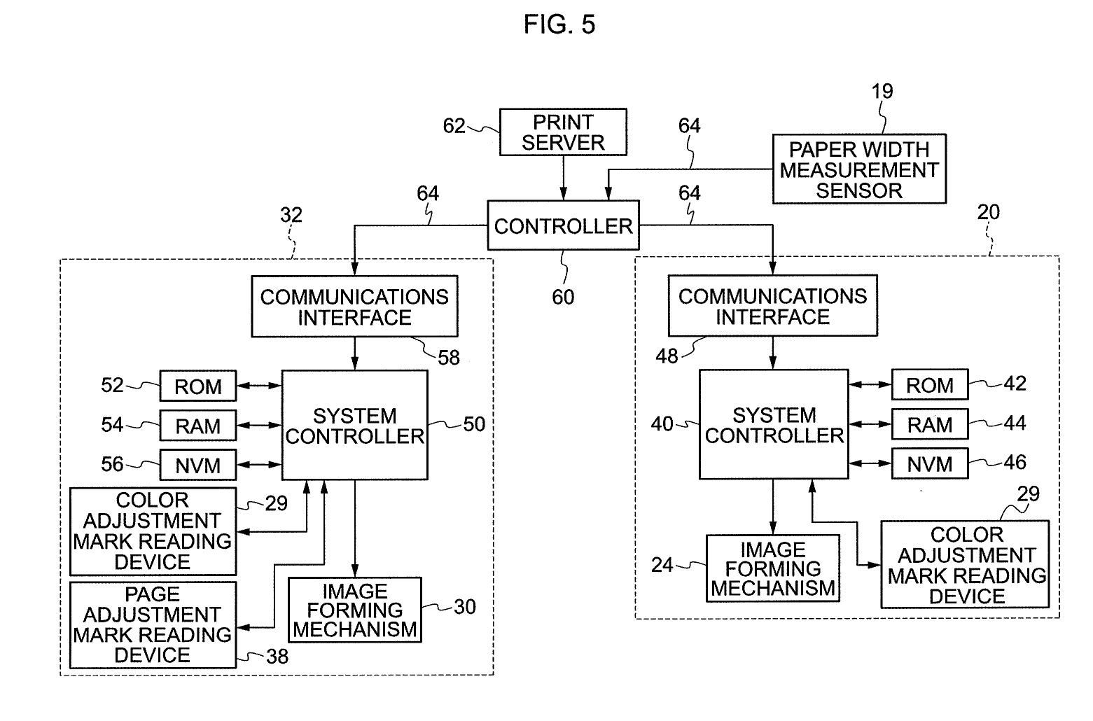

As illustrated in FIG. 5, the image forming device 20 of the upstream side system 12 is structured to include a system controller 40, read-only memory (ROM) 42, random access memory (RAM) 44, non-volatile memory (NVM) 46 and a communications interface 48. The ROM 42, the RAM 44, the NVM 46, the communications interface 48, the image forming mechanism 24 and the color adjustment mark reading device 29 are connected to the system controller 40.

The ROM 42 functions as a memory component in which an image forming processing program, various parameters, various data required for control, and the like are pre-memorized. The RAM 44 is used as a work area during execution of various programs, and the like. The NVM 46 memorizes various kinds of information that need to be retained if a power switch of the equipment is turned off.

The system controller 40 is constituted by a central processing unit (CPU) and peripheral circuits thereof and the like. The system controller 40 functions as a control device that controls the upstream side system 12 at the conveyance direction upstream side as a whole, in accordance with pre-specified programs. The system controller 40 also functions as a computing device that performs various kinds of computing. That is, the system controller 40 controls operations of the image forming mechanism 24, controls reading and writing of the ROM 42, the RAM 44 and the NVM 46, and so forth.

The image forming device 32 of the downstream side system 14 is structured to include a system controller 50, read-only memory (ROM) 52, random access memory (RAM) 54, non-volatile memory (NVM) 56 and a communications interface 58. The ROM 52, the RAM 54, the NVM 56, the communications interface 58, the color adjustment mark reading device 29, the page adjustment mark reading device 38 and the image forming mechanism 30 are connected to the system controller 50.

The ROM 52 functions as a memory component in which an image forming processing program, various parameters, various data required for control, and the like are pre-memorized. The RAM 54 is used as a work area during execution of various programs, and the like. The NVM 56 memorizes various kinds of information that need to be retained if the power switch of the equipment is turned off.

The system controller 50 is constituted by a central processing unit (CPU) and peripheral circuits thereof and the like. The system controller 50 functions as a control device that controls the downstream side system 14 as a whole, in accordance with pre-specified programs. The system controller 50 also functions as a computing device that performs various kinds of computing. That is, the system controller 50 controls operations of the image forming mechanism 30, controls reading and writing of the ROM 52, the RAM 54 and the NVM 56, and so forth.

The image forming system 10 is further provided with a controller 60 and a print server 62 that outputs image formation instructions (print instructions) to the controller 60. The image forming devices 20 and 32, the paper width measurement sensor 19 and the controller 60 are connected by a communications component 64 so as to exchange data and commands with one another. A structure is possible in which the print server 62 is included in the image forming system 10. The print server 62 is constituted by an ordinary server and the controller 60 is constituted by an ordinary personal computer.

The print server 62 outputs duplex print data to the controller 60 as image forming instructions.

The controller 60 outputs, to the image forming device 20, image forming instructions that include first face print data for forming images on the first face of the continuous paper 21 and width information of the continuous paper 21 measured by the paper width measurement sensor 19. The controller 60 also outputs, to the image forming device 32, image forming instructions that include second face print data for forming images on the second face of the continuous paper 21 and width information of the continuous paper 21 that is set in advance for the first face print data and the second face print data.

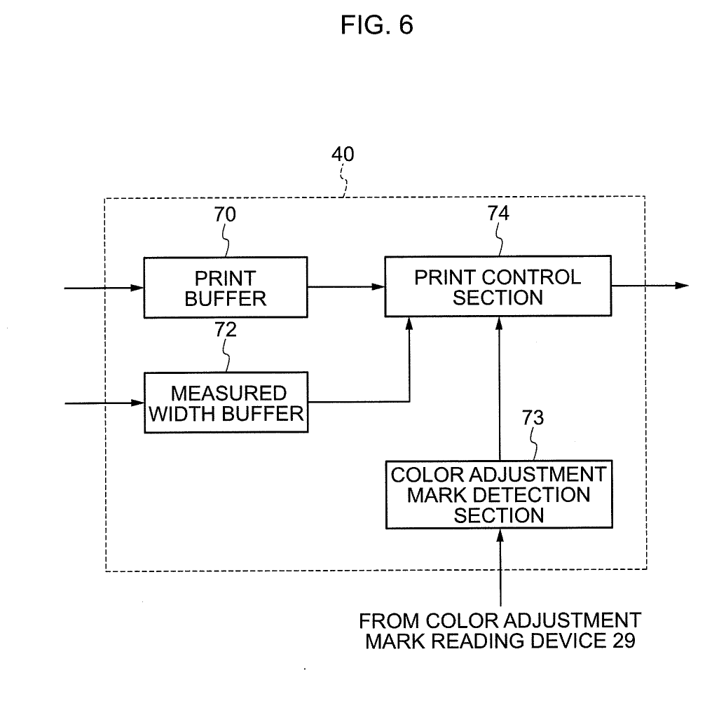

If the system controller 40 of the image forming device 20 is represented by functional blocks, as illustrated in FIG. 6, the system controller 40 is provided with a print buffer 70, a measured width buffer 72, a color adjustment mark detection section 73 and a print control section 74.

The print buffer 70 temporarily memorizes print data inputted from the controller 60. The measured width buffer 72 temporarily memorizes measured width information for the continuous paper 21, which is inputted from the controller 60.

The color adjustment mark detection section 73 detects color adjustment marks from images that are read by the color adjustment mark reading device 29.

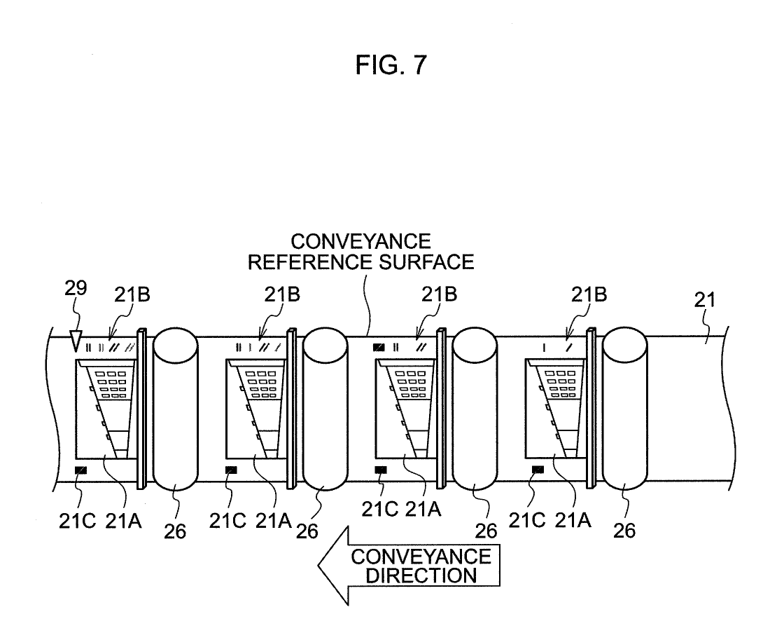

On the basis of the first face print data, color adjustment mark image data and page adjustment mark image data, the print control section 74 controls the image forming mechanism 24 so as to form images 21A represented by the first face print data, color adjustment marks 21B and page adjustment marks 21C on the first face of the continuous paper 21, as illustrated in FIG. 7. On the basis of detection results according to the color adjustment mark detection section 73, the print control section 74 controls the image forming mechanism 24 so as to reduce mispositioning in the conveyance direction of images of respective colors that are formed by the respective photoreceptor drums 26.

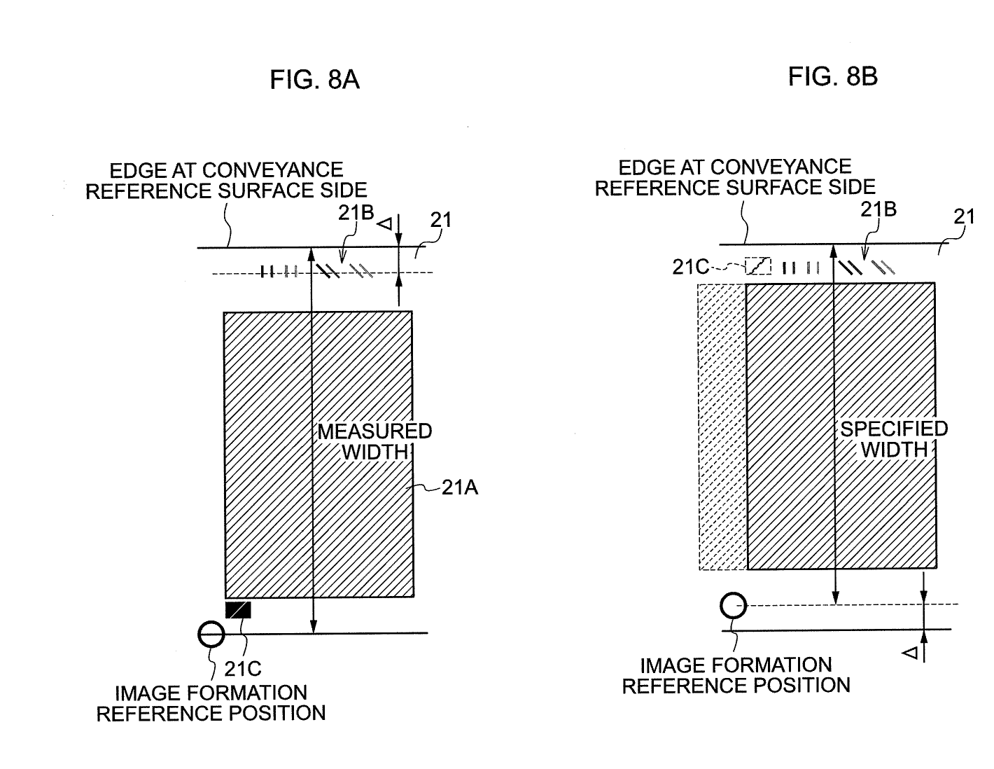

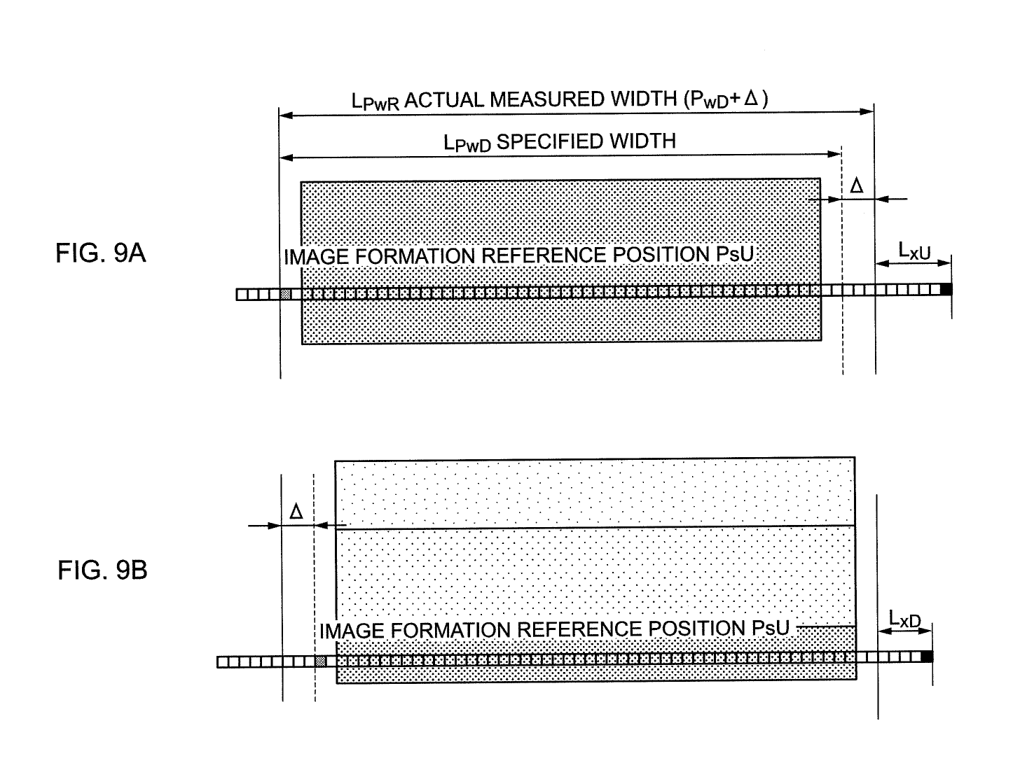

At the print control section 74, as illustrated in FIG. 8A, an image formation reference position (a writing start position) is determined on the basis of a position that is separated by a measured width from the one side edge of the continuous paper 21 that is abutted against the conveyance reference surface, and the images 21A represented by the first face print data, the color adjustment marks 21B and the page adjustment marks 21C are formed on the first face of the continuous paper 21. For example, the image formation reference position is determined as illustrated in FIG. 9A. Here, a method of determining the image formation reference position for an exposure system based on an LED array is described as an example. In the image forming device 20, the image formation reference position is calculated using a measured actual paper width. Because mounting errors arise between the LED array and the continuous paper 21, an adjustment value Lₓᵤ for matching the side edge position of the continuous paper 21 with a dot position of the LED array is set in advance.

Now, in the image forming device 20, if a measured width of the continuous paper 21 is denoted by L_{PwR}, an image formation reference position P_{sU} (a dot position in the LED array) relative to the side edge position of the continuous paper 21 is calculated with the following expression (1).

P_{sU}=L_{PwR}+L_{xU} (1)

Herein, as illustrated in the aforementioned FIG. 7, the page adjustment marks 21C are formed at a fixed position of each page. The page adjustment marks 21C are formed on the first face of the continuous paper 21 with a spacing corresponding to a page continuation direction size of the pages.

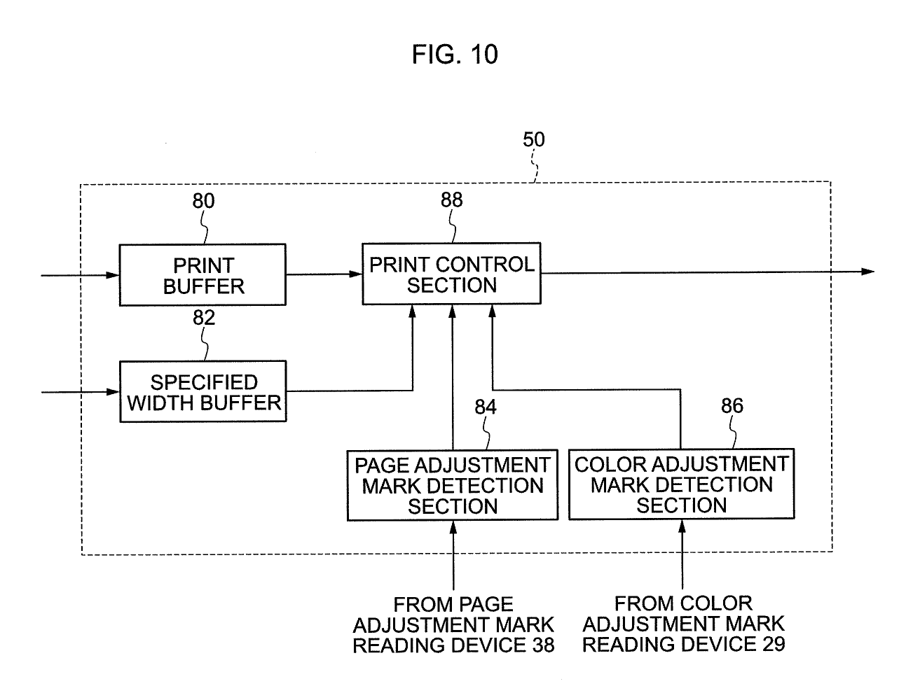

If the system controller 50 of the image forming device 32 is represented by functional blocks, as illustrated in FIG. 10, the system controller 50 is provided with a print buffer 80, a specified width buffer 82, a page adjustment mark detection section 84, a color adjustment mark detection section 86 and a print control section 88.

The print buffer 80 temporarily memorizes print data inputted from the controller 60. The specified width buffer 82 temporarily memorizes width information of the continuous paper 21 inputted from the controller 60, which is specified beforehand in relation to the print data.

The page adjustment mark detection section 84 detects page adjustment marks from images read by the page adjustment mark reading device 38. The color adjustment mark detection section 86 detects color adjustment marks from images read by the color adjustment mark reading device 29.

On the basis of second face print data and the color adjustment mark image data, the print control section 88 controls the image forming mechanism 30 so as to form images represented by the second face print data and color adjustment marks on the second face of the continuous paper 21, in accordance with page adjustment mark detection timings according to the page adjustment mark detection section 84. Further, on the basis of detection results from the color adjustment mark detection section 86, the print control section 88 controls the image forming mechanism 30 so as to reduce mispositioning in the conveyance direction of images of respective colors that are formed by the respective photoreceptor drums 26.

At the print control section 88, as illustrated in FIG. 8B, an image formation reference position (a writing start position) is determined on the basis of a position that is separated by a pre-specified width from the other side edge of the continuous paper 21 that is abutted against the conveyance reference surface, and the images 21A represented by the second face print data and the color adjustment marks 21B are formed on the second face of the continuous paper 21. For example, the image formation reference position is determined as illustrated in FIG. 9B. In the image forming device 32, the image formation reference position is calculated using a pre-specified paper width. Because mounting errors arise between the LED array and the continuous paper 21, an adjustment value L_{xD} for matching the side edge position of the continuous paper 21 with a dot position of an LED array is set in advance.

In the image forming device 32, if a specified width of the continuous paper 21 is denoted by L_{PwD}, an image formation reference position P_{sD} (a dot position in the LED array) relative to the side edge position of the continuous paper 21 is calculated with the following expression (2).

P_{sD}=L_{PwD}+L_{xD} (2)

Next, operations of the image forming system 10 relating to the first exemplary embodiment are described.

First, when the controller 60 receives image forming instructions from the print server 62, width information of the continuous paper 21 is acquired from the paper width measurement sensor 19 and image formation control processing is executed at the CPU of the controller 60. Here, the image forming instructions include an image forming instruction that includes instructions to form images at both faces (the first face and the second face) of the continuous paper 21, and include first face print data and second face print data representing images to be formed on the continuous paper 21 and pre-specified width information of the continuous paper 21 for the first face print data and the second face print data.

The controller 60 compares the width information acquired from the paper width measurement sensor 19 included in the image forming instruction with the pre-specified width information of the continuous paper 21 included in the image forming instruction, and determines whether or not a difference between the sets of width information is at or above a pre-specified value. If the difference between the sets of width information is at or above the pre-specified value, the controller 60 judges that there is a problem with specifications or a problem with the continuous paper 21, and the image formation control processing stops.

The controller 60 inputs the first face print data representing images to be formed at the first face and the paper width information acquired from the paper width measurement sensor 19, which are included in the image forming instruction, to the image forming device 20. The controller 60 also inputs the second face print data representing images to be formed at the second face and the pre-specified paper width information of the continuous paper 21, which are included in the image forming instruction, to the image forming device 32.

The system controller 40 of the image forming device 20 determines the image formation reference position on the basis of the inputted width information measured for the continuous paper 21 and controls the image forming mechanism 24 so as to form the images 21A represented by the first face print data, the color adjustment marks 21B and the page adjustment marks 21C at the first face of the continuous paper 21. Thus, the images 21A represented by the first face print data, the color adjustment marks 21B and the page adjustment marks 21C are formed on respective pages of the first face of the continuous paper 21. Moreover, the system controller 40 detects the color adjustment marks from images read by the color adjustment mark reading device 29, and controls the image forming mechanism 24 on the basis of the detection results so as to reduce conveyance direction mispositioning of the images of the respective colors that are formed by the respective photoreceptor drums 26.

The system controller 50 of the image forming device 32 determines the image formation reference position on the basis of the inputted width information specified in advance for the continuous paper 21. Then the system controller 50 detects the page adjustment marks from images read by the page adjustment mark reading device 38, and controls the image forming mechanism 30 so as to form the images 21A represented by the first face print data and the color adjustment marks 21B at the second face of the continuous paper 21 in accordance with detection timings of the page adjustment marks. Thus, the images 21A represented by the first face print data and the color adjustment marks 21B are formed on respective pages of the second face of the continuous paper 21. Moreover, the system controller 50 detects the color adjustment marks from images read by the color adjustment mark reading device 29, and controls the image forming mechanism 30 on the basis of the detection results so as to reduce conveyance direction mispositioning of the images of the respective colors that are formed by the respective photoreceptor drums 26.

As described above, the image formation reference position at the conveyance direction upstream side image forming device 20 is determined on the basis of the measured width information of the continuous paper 21, and the image formation reference position at the conveyance direction downstream side image forming device 32 is determined on the basis of the preset width information of the continuous paper 21. Therefore, the amount of an error in the width information of the continuous paper 21 is assigned to the same width direction side edge of the continuous paper 21 for both the first face and the second face of the continuous paper 21.

Hence, at the post-processing device 36, the continuous paper 21 is cut to match the size of the images formed at both faces—the first face and the second face—of the continuous paper 21.

Next, a second exemplary embodiment is described. Here, because structure of an image forming system relating to the second exemplary embodiment is the same structure as in the first exemplary embodiment, the same reference numerals are assigned and descriptions concerning structures are not given.

The second exemplary embodiment principally differs from the first exemplary embodiment in that even though the first face and second face of the continuous paper 21 are exchanged by an inversion device, width direction edges of the continuous paper 21 are not exchanged.

In the inversion device 22 of the image forming system relating to the second exemplary embodiment, the first face and second face of the continuous paper 21 are swapped over (exchanged) without the width direction edges of the continuous paper 21 being exchanged.

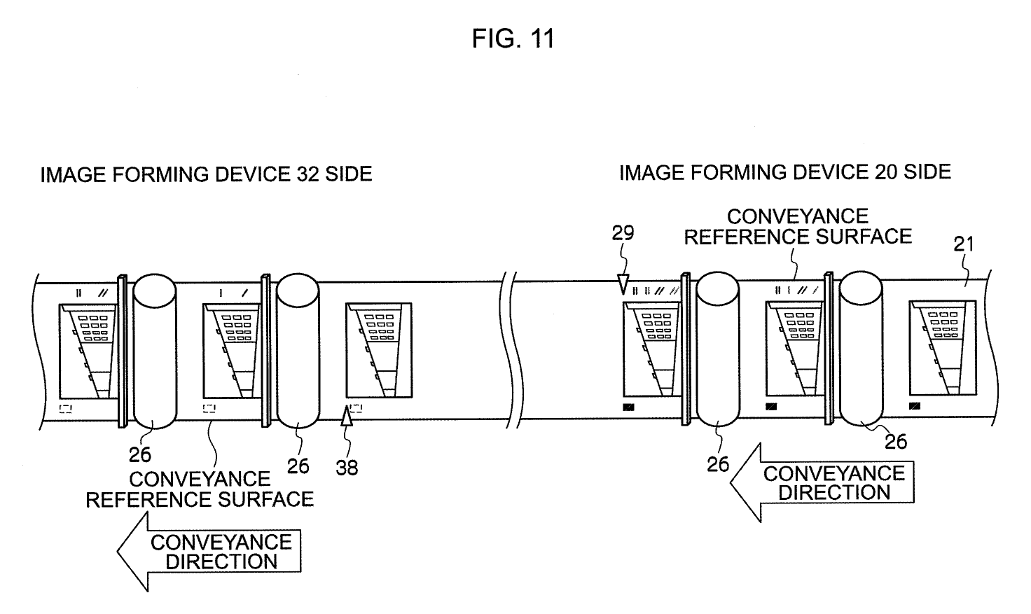

As illustrated in FIG. 11, a conveyance reference surface of the image forming device 20 is disposed on the conveyance path at the one edge side of the direction orthogonal to the conveyance direction, and a conveyance reference surface of the image forming device 32 is disposed on the conveyance path at the other edge side of the direction orthogonal to the conveyance direction. Thus, the width direction side edges of the continuous paper 21 that are abutted against the conveyance reference surfaces are different between the image forming devices 20 and 32.

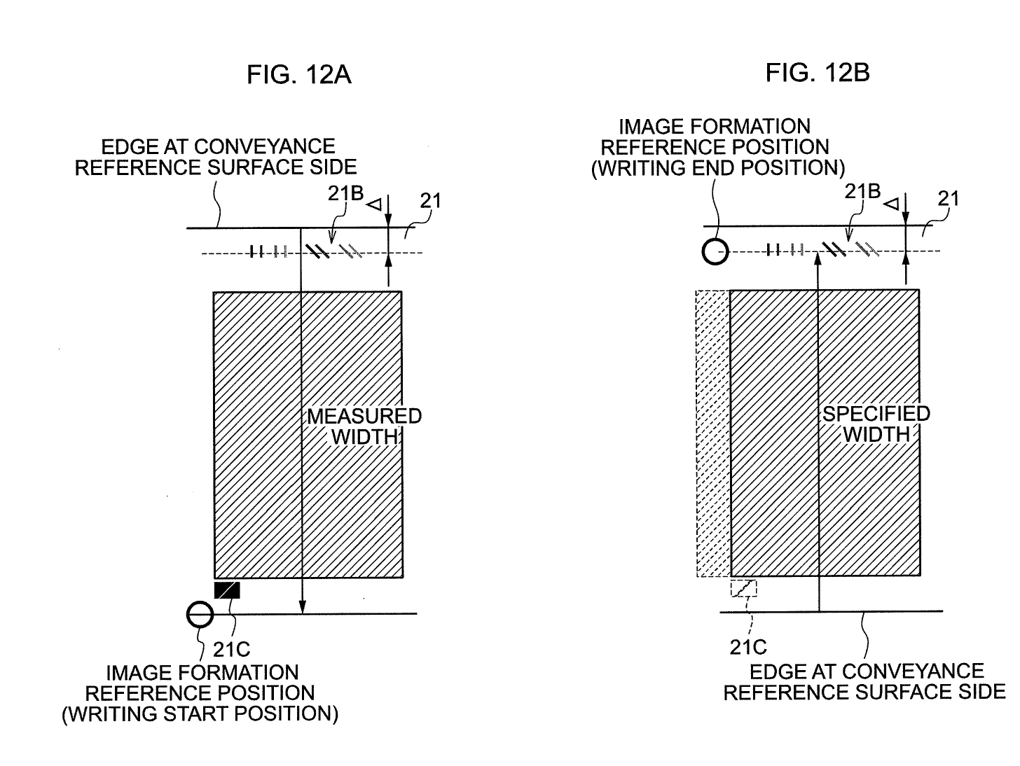

At the image forming device 20, as illustrated in FIG. 12A, the image formation reference position (the writing start position) is determined on the basis of a position that is separated by a measured width from the one side edge of the continuous paper 21 that is abutted against the conveyance reference surface, and the images 21A represented by the first face print data, the color adjustment marks 21B and the page adjustment marks 21C are formed on the first face of the continuous paper 21.

At the image forming device 32, as illustrated in FIG. 12B, an image formation reference position (a writing end position) is determined on the basis of a position that is separated by a pre-specified width from the other side edge of the continuous paper 21 that is abutted against the conveyance reference surface, and the images 21A represented by the second face print data and the color adjustment marks 21B are formed on the second face of the continuous paper 21.

As described above, the image formation reference position at the conveyance direction upstream side image forming device 20 is determined on the basis of the measured width information of the continuous paper 21, and the image formation reference position at the conveyance direction downstream side 32 is determined on the basis of the pre-specified width information of the continuous paper 21. Therefore, the amount of an error in the width information of the continuous paper 21 is assigned to the same width direction side edge of the continuous paper 21 for both the first and second faces of the continuous paper 21.

Other structures and operations of the image forming system relating to the second exemplary embodiment are the same as in the first exemplary embodiment, so will not be described.

Hereabove, in the first exemplary embodiment and the second exemplary embodiment, cases in which the image formation reference position at the conveyance direction upstream side image forming device is determined using measured width information and the image formation reference position at the conveyance direction downstream side image forming device is determined using pre-specified width information have been described as examples, but these are not to be limiting. An image formation reference position at a conveyance direction upstream side image forming device may be determined using pre-specified width information and an image formation reference position at a conveyance direction downstream side image forming device may be determined using measured width information.

Furthermore, cases in which images are formed at both sides of the continuous paper by the conveyance direction upstream side image forming device and the conveyance direction downstream side image forming device have been described as examples, but these are not to be limiting. Images may be formed at only one face of the continuous paper in accordance with image forming instructions. In such a case, at the conveyance direction upstream side image forming device, the image formation reference position is determined using measured width information and an image is formed at the one face of the continuous paper, and at the conveyance direction downstream side image forming device, it is sufficient to perform processing to convey the continuous paper without forming an image.

A case in which the width of the continuous paper is measured by the paper width measurement sensor at the pre-processing device has been described as an example, but this is not to be limiting. The paper width measurement sensor may be provided and measure the width of the continuous paper in the conveyance direction upstream side image forming device. Further, paper width measurement sensors may be provided in both the conveyance direction upstream side image forming device and the conveyance direction downstream side image forming device, and each measure the width of the continuous paper. In such a case, it may be determined whether or not error amounts between the measured width information and the pre-specified width information are at or above a preset value in both the conveyance direction upstream side image forming device and the conveyance direction downstream side image forming device, and the image forming processing may be stopped if the error amount is determined to be at or above the preset amount at either or both of the image forming devices.

Next, a third exemplary embodiment is described. Here, portions with similar structures to the first exemplary embodiment are assigned the same reference numerals and are not described.

The third exemplary embodiment differs from the first exemplary embodiment in that images are formed at both faces of the continuous paper by a single image forming device.

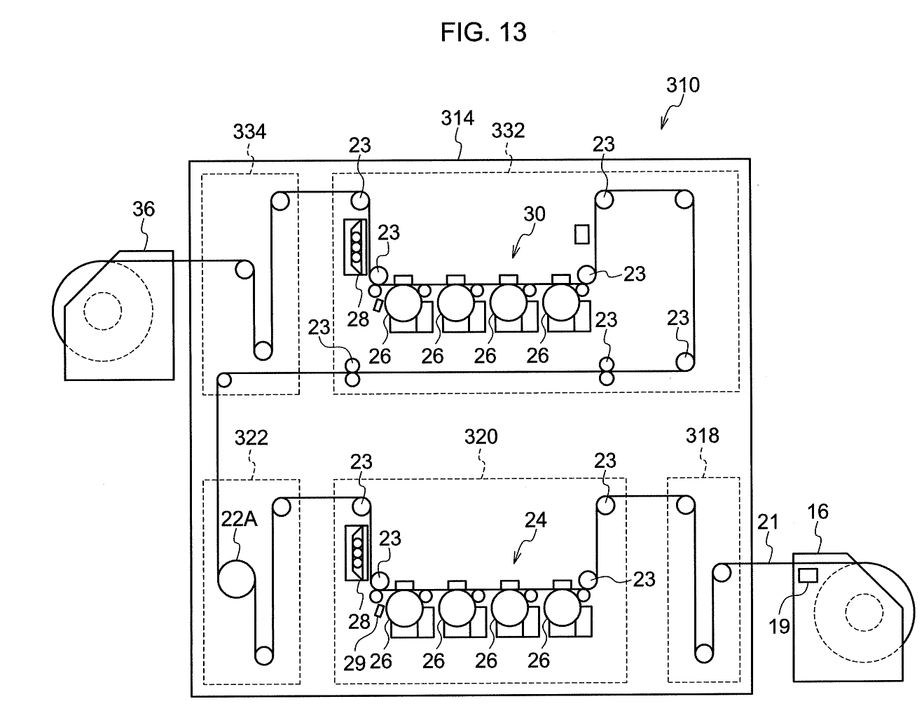

As illustrated in FIG. 13, an image forming system 310 relating to the third exemplary embodiment is provided with the pre-processing device 16, an image forming device 314 and the post-processing device 36.

The image forming device 314 is provided with a buffer section 318, an upstream side image forming section 320, the inversion device 22, a downstream side image forming section 332 and a buffer section 334. The buffer section 318, the upstream side image forming section 320, the downstream side image forming section 332 and the buffer section 334 have similar structures to the buffer device 18, the image forming device 20, the image forming device 32 and the buffer device 34 described in the first exemplary embodiment. Therefore, descriptions concerning the structures thereof will not be given.

At the upstream side image forming section 320, the image formation reference position is determined on the basis of the measured width information of the continuous paper 21, and at the downstream side image forming section 332, the image formation reference position is determined on the basis of the pre-specified width information of the continuous paper 21. Thus, the amount of an error in the width information of the continuous paper 21 is assigned to the same width direction side edge of the continuous paper 21 at both the first face and the second face of the continuous paper 21 by the upstream side image forming section 320 and the downstream side image forming section 332.

Other structures and operations of the image forming system relating to the third exemplary embodiment are the same as in the first exemplary embodiment, so will not be described.

In the exemplary embodiment described hereabove, a case in which the image formation reference position at the conveyance direction upstream side image forming section is determined using measured width information and the image formation reference position at the conveyance direction downstream side image forming section is determined using pre-specified width information has been described as an example, but this is not to be limiting. The image formation reference position at the conveyance direction upstream side image forming section may be determined using pre-specified width information and the image formation reference position at the conveyance direction downstream side image forming section may be determined using measured width information.

Furthermore, a case in which images are formed at both sides of the continuous paper by the conveyance direction upstream side image forming section and the conveyance direction downstream side image forming section has been described as an example, but this is not to be limiting. Images may be formed at only one face of the continuous paper in accordance with image forming instructions. In such a case, at the conveyance direction upstream side image forming section, the image formation reference position is determined using measured width information and an image is formed at the one face of the continuous paper, and at the conveyance direction downstream side image forming section, it is sufficient to perform processing to convey the continuous paper without forming an image.

A case in which the width of the continuous paper is measured by the paper width measurement sensor at the pre-processing device has been described as an example, but this is not to be limiting. The paper width measurement sensor may be provided and measure the width of the continuous paper in the conveyance direction upstream side image forming section. Further, paper width measurement sensors may be provided in both the conveyance direction upstream side image forming section and the conveyance direction downstream side image forming section, and each measure the width of the continuous paper. In such a case, it is determined whether or not error amounts between the measured width information and the pre-specified width information are at or above a preset value in both the conveyance direction upstream side image forming section and the conveyance direction downstream side image forming section, and the image forming processing may be stopped if the error amount is determined to be at or above the preset amount at either or both of the image forming sections.

Further still, in the first exemplary embodiment to third exemplary embodiment described above, cases in which the image forming devices form images on the continuous paper using toners as materials for forming images have been described, but this is not to be limiting. An image forming device may form images on continuous paper using inks as materials for forming images. Furthermore, materials for forming these images are not to be limited to toners and inks, and may be other materials.

Cases in which the measured width information is acquired when the controller has received an image forming instruction from the print server have been described, but this is not to be limiting. For example, measured width information may be acquired from the paper width measurement sensor when the continuous paper is loaded at the pre-processing device.

What is claimed is:

1. An image forming system comprising:
an inversion mechanism that inverts continuous paper between one side and the other side of the continuous paper;
an upstream side image forming device; and
a downstream side image forming device, wherein
the upstream side image forming device includes:
a first conveyance component that aligns a first side edge of the continuous paper with a reference surface provided along a conveyance direction and conveys the continuous paper in a conveyance direction, the conveyance direction being in a paper continuation direction; and
a first, image forming component that forms an image on one side of the continuous paper conveyed by the first conveyance component based on a first reference position, the first reference position being a position that is disposed away from the first side edge of the continuous paper by a first width which is one of a measured width of the continuous paper and a pre-specified width for the continuous paper, and
the downstream side image forming device includes:
a second conveyance component that aligns a second side edge, which is opposite to the first side edge, of the continuous paper with a reference surface provided along the conveyance direction and conveys the inverted continuous paper by the inversion mechanism in the conveyance direction; and
a second image forming component that forms an image on the other side of the continuous paper conveyed by the second conveyance component based on a second reference position, the second reference position being a position that is disposed away from the second side edge by a second width which is the other of the measured width of the continuous paper and the pre-specified width for the continuous paper, and wherein
the upstream side image forming device is disposed at a upstream side of the inversion mechanism in the conveyance direction, and
the downstream side image forming device is disposed at a downstream side of the inversion mechanism in the conveyance direction.

2. The image forming system of claim 1, wherein
the first width is the measured width of the continuous paper, and
the second width is the pre-specified width of the continuous paper.

3. The image forming system of claim 1, wherein
the first width is the pre-specified width of the continuous paper, and
the second width is the measured width of the continuous paper.

4. The image forming system of claim 1, further comprising a pre-processing device that is disposed at the upstream side of the upstream side image forming device, wherein
the pre-processing device measures the measured width of the continuous paper.

5. The image forming system of claim 1, wherein at least one of the first image forming component and the second image forming component measures the measured width of the continuous paper.

6. An image forming device comprising:
a first conveyance component that aligns a first side edge of continuous paper with a reference surface provided along a conveyance direction and conveys the continuous paper in a conveyance direction, the conveyance direction being in a paper continuation direction;
a first image forming component that forms an image on one side of the continuous paper conveyed by the first conveyance component based on a first reference position, the first reference position being a position that is disposed away from the first side edge of the continuous paper by a first width which is one of a measured width of the continuous paper and a pre-specified width for the continuous paper;
an inversion mechanism that inverts the continuous paper on which the image has been formed by the first image forming component between one side and the other side of the continuous paper;
a second conveyance component that aligns a second side edge, which is opposite to the first edge, of the continuous paper with a reference surface provided along the conveyance direction and conveys the inverted continuous paper by the inversion mechanism in the conveyance direction; and
a second image forming component that forms an image on the other side of the continuous paper conveyed by the second conveyance component based on a second reference position, the second reference position being a position that is disposed away from the second side edge by a second width which is the other of the measured width of the continuous paper and the pre-specified width for the continuous paper.

7. The image forming device of claim 6, wherein
the first width is the measured width of the continuous paper, and
the second width is the pre-specified width of the continuous paper.

8. The image forming device of claim 6, wherein
the first width is the pre-specified width of the continuous paper, and
the second width is the measured width of the continuous paper.

9. The image forming device of claim 6, wherein at least one of the first image forming component and the second image forming component measures the measured width of the continuous paper.
